(19) United States
(12) Patent Application Publication
(10) Pub. No.: US 2015/0343872 A1
(43) Pub. Date: Dec. 3, 2015

(54) Suspension System for Motor Vehicles

(71) Applicant: Equipements FDS Inc., Terrebonne (CA)

(72) Inventor: Daniel Drapeau, St-Mathieu-de-Beloeil (CA)

(73) Assignee: Equipements FDS Inc., Terrebonne (CA)

(21) Appl. No.: 14/545,612

(22) Filed: May 29, 2015

(30) Foreign Application Priority Data
May 30, 2014 (CA) 2853773

(51) Int. Cl. B60G 11/27; B60G 11/28

(52) U.S. Cl. CPC B60G 11/27; B60G 11/28

(57) ABSTRACT

There is provided an improved vehicle suspension system for a vehicle which has frame members, the improvement comprising a mounting plate formed of a high tensile strength steel, the mounting plate having a planar central portion, first and second legs extending diagonally upwardly therefrom, first and second air springs mounted on the planar central portion with an upper end of each of the air springs being connected to a respective frame member.

### FIELD OF THE INVENTION

The present invention is related to an axle suspension for wheeled motor vehicles.

### BACKGROUND OF THE INVENTION

Truck suspension systems provide isolation of passengers and cargo from road shock while keeping the vehicle stable and preserving operator control. Generally, these objectives are met using various combinations of springs, motion dampening devices and auxiliary axle positioning elements.

The central element of any suspension system is the spring and there are many different types of suspension systems. The basic types of suspension systems used on trucks include leaf spring systems, equalizing beam systems, torsion bar systems and air spring systems. Hybrid combinations of these are also used.

Leaf spring based systems are relatively popular and have been applied to both steering and non steering axles as well as driven and non driven axles. In an air based system, air bellows known as convoluted air springs are positioned with respect to an axle vehicle frame to support the frame from, the axle. Air spring systems are known to provide excellent load and vibration isolation compared to traditional leaf spring systems. Air springs usually have a lower deflection rate than a leaf spring exerting the same force giving the system greater capacity for absorbing shocks for a given displacement between the axle and the frame. Air spring pressure can also be adjusted to compensate for vehicle load changes by adding air to or exhausting air from the spring.

One weakness of air spring suspension systems is that they require more auxiliary stabilization to maintain the proper location and attitude of the axle with respect to the vehicle and to prevent excessive vehicle roll. Absent stabilization, air springs can extend to their maximum lengths or widths in the direction of least resistance and can cause an unevenly loaded vehicle to tip over to one side. Full leaf springs do not suffer from this disadvantage.

### SUMMARY OF THE INVENTION

It is an object of the present invention to provide a stabilization arrangement for air spring based suspension systems.

According to one aspect of the present invention, there is provided an improvement in a vehicle suspension system for a vehicle having frame members, the improvement comprising a mounting plate, the mounting plate being formed of a high tensile strength steel, the mounting plate having a planar central portion, first and second legs extending diagonally upwardly from the planar central portion on one side thereof, first and second air springs mounted on the planar central portion, an upper end of each of the air springs connecting to a respective frame member, and first and second brackets, each of the brackets being connected to a respective frame member and to a free end of a respective one of the first and second legs.

According to a preferred aspect of the present invention, the mounting plate is formed of a suitable steel material and will have a tensile strength of at least 100,000 psi and more preferably has a tensile strength of between 100,000 and 130,000 psi.

In one aspect of the present invention, the mounting plate will preferably have a thickness of between ½ inch and one inch. Naturally, greater thicknesses could be utilized and as will be shown in the preferred embodiments, reinforcing plates may be utilized. In such an instance, the combined thicknesses will be at least ½ inch.

The air springs extend between the frame of the vehicle and the mounting plate. Suitable attachment means known in the art may be utilized. One skilled in the art may utilize any known air spring; however, in a preferred embodiment, triple convoluted air springs are employed.

In one particular embodiment, further air springs are also provided and mounted in a horizontal mode.

The securement of the various components together may be accomplished by any suitable means. Thus, suitable mechanical fasteners may be utilized along with welding of the materials.

### BRIEF DESCRIPTION OF THE DRAWINGS

Having thus generally described the invention, reference will be made to the accompanying drawings illustrating an embodiment thereof, in which:

FIG. 1 is an exploded view showing the mounting plate and associated components;

FIG. 2 is a side elevational view thereof;

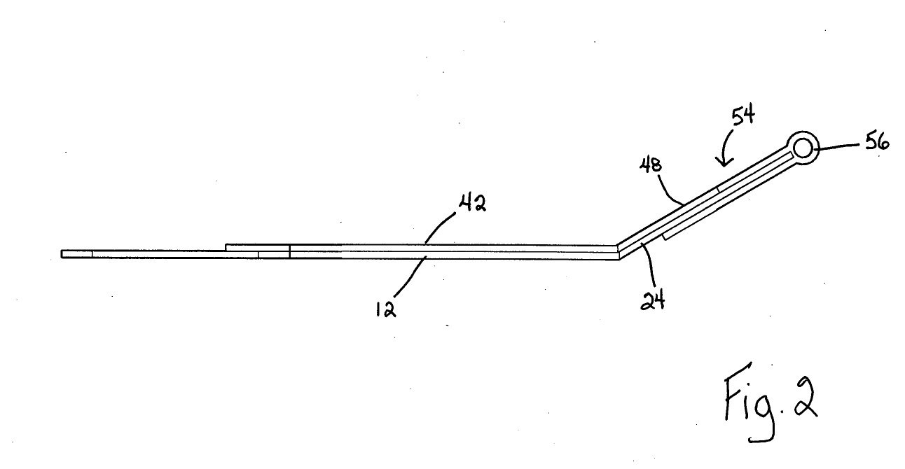

FIG. 3 is a top plan view thereof;

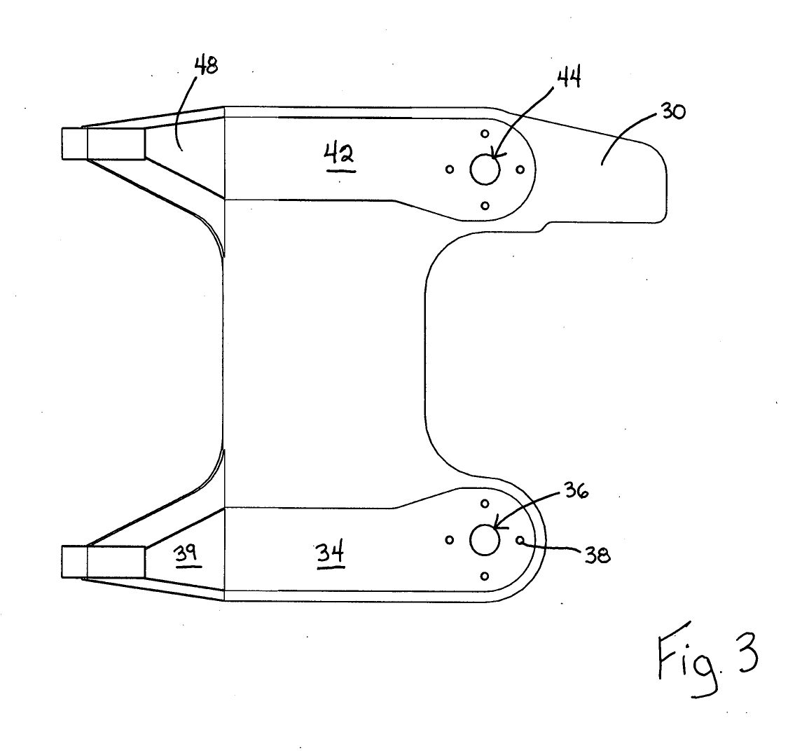

FIG. 4 is an exploded view illustrating components forming the suspension system;

FIG. 5 is a side perspective view illustrating the suspension system;

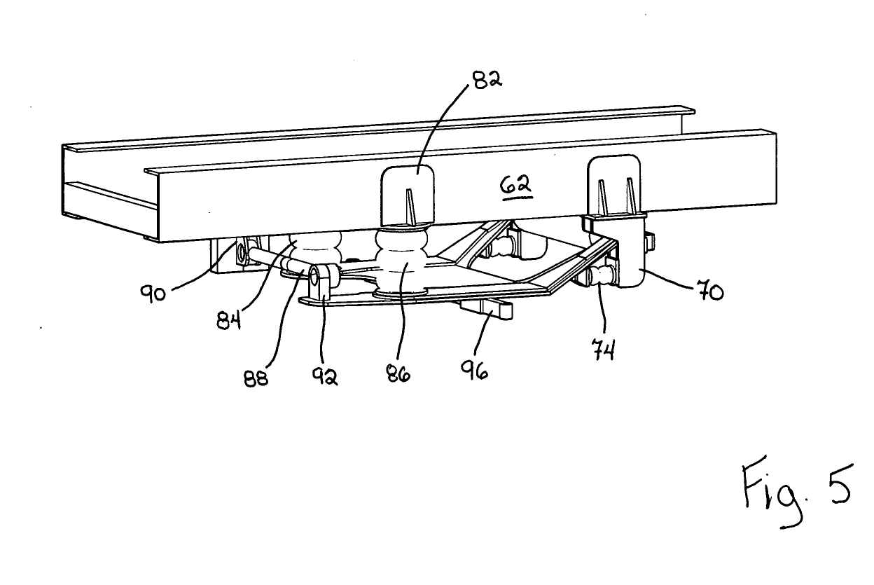

FIG. 6 is a side perspective view from the other side of the suspension system; and

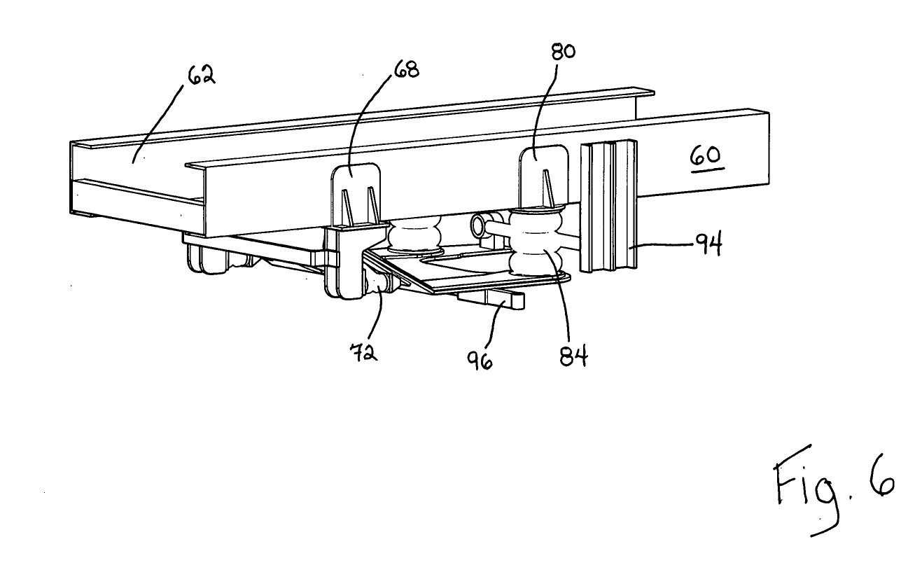

FIG. 7 is a side elevational view thereof.

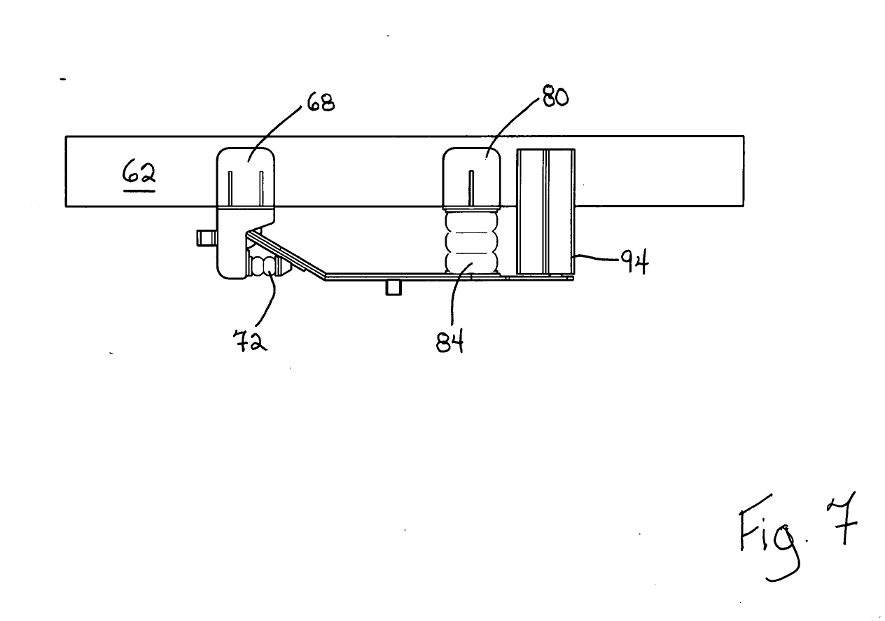

### DETAILED DESCRIPTION OF THE INVENTION

Referring to the drawings in greater detail and by reference characters thereto, the suspension system includes a mounting plate generally designated by reference numeral 10. Mounting plate 10 includes a planar central portion 12 which is partially defined by a first side wall 14 and a second side wall 16 which is substantially parallel thereto. Planar central portion 12 is also further defined by a first end wall 18 and a second end wall 20.

Mounting plate 10 includes a first leg 22 which extends diagonally upwardly from end wall 18 proximate to side wall 14. As will be noted, first leg 22 has a somewhat triangular configuration.

A second leg 24 also extends diagonally upwardly from end wall 18 adjacent second side wall 16.

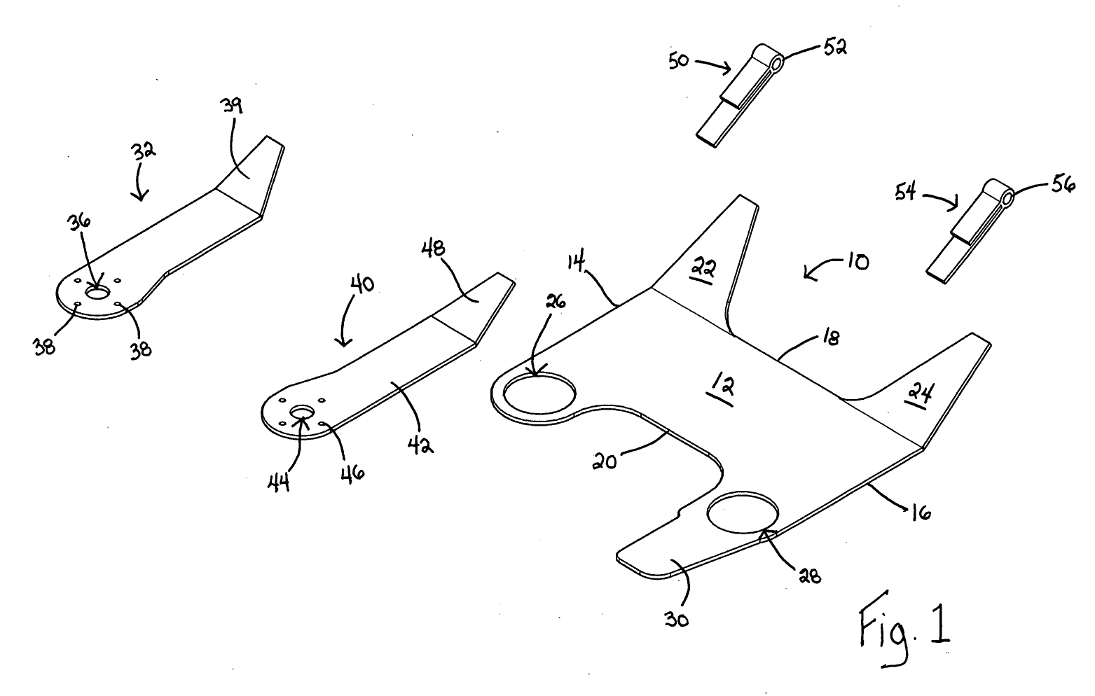

Mounting plate 10 also includes a pair of mounting apertures 26 and 28 as may be seen in FIG. 1. Along side wall 16, there is provided an extension 30.

The system includes a first reinforcing element generally designated by reference numeral 32. First reinforcing element 32 includes a central portion 34 and having at one end thereof a mounting aperture 36. A plurality of smaller apertures 38 for connecting the same are provided. First reinforcing element 32 also includes a leg 39. Leg 39 extends diagonally upwardly and is intended to overlay leg 22 of mounting plate 10.

A second reinforcing element 40 also has a central portion 42 with a mounting aperture 44 at one end thereof. Similar to first reinforcing element 32, there is provided a plurality of smaller mounting apertures 46. A leg 48 extends diagonally upwardly and is arranged to overlay leg 24 of mounting plate 10.

A first connecting arm 50 is arranged to be secured to leg 22 and includes a bushing 52 at one end thereof. A second connecting arm 54 is arranged to be secured to second leg 24 and also has a bushing 56 at an end thereof.

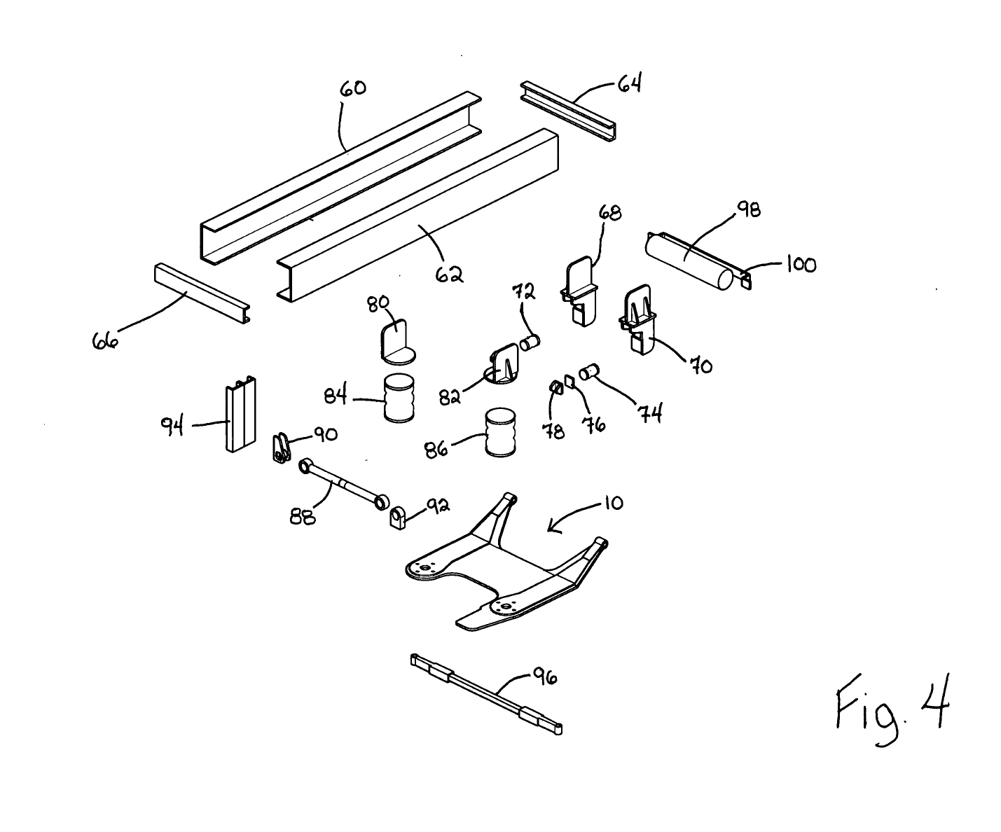

As may be seen in FIG. 4, the suspension system is designed to be coupled to a vehicle which has longitudinally extending frame members 60 and 62. The arrangement may include transverse connecting frame members 64 and 66.

First and second brackets 68, 70 are provided as will be discussed in greater detail hereinbelow. The arrangement includes a pair of double convoluted air springs 72, 74 which are arranged to attach by means of bracket members 76, 78, 80 and 82.

The suspension system includes a pair of triple convoluted air springs 84 and 86 which extend between mounting plate 10 and frame members 60 and 62.

If desired, a reinforcing bar 88 may be utilized; reinforcing bar 88 is connected through brackets 90 and 92. The system may also include a vertical connecting member 94.

As shown in the drawings, the mounting plate 10 will be connected to an axle 96.

An air tank 98 may also be provided along with an air tank mounting assembly 100.

It will be understood that the above described arrangement is for purposes of illustration only and that changes and modifications may be made thereto without departing from the spirit and scope of the invention.

I claim:

1. In a vehicle suspension system for a vehicle having frame members, the improvement comprising:
a mounting plate, said mounting plate being formed of a high tensile strength steel, said mounting plate having a planar central portion, first and second legs extending diagonally upwardly from said planar central portion on one side thereof;
first and second air springs mounted on said planar central portion, an upper end of each of said air springs connecting to a respective frame member; and
first and second brackets, each of said brackets being connected to a respective frame member and to a free end of a respective one of said first and second legs.

2. The improvement of claim 1 wherein said mounting plate has a thickness of between ½ inch and 1 inch.

3. The improvement of claim 2 wherein said mounting plate has a tensile strength of between 100,000 and 130,000 psi.

4. The improvement of claim 3 wherein said mounting plate is formed of a plurality of layers.

5. The improvement of claim 1 further including first and second connecting arms between a respective bracket and a respective free end.

6. The improvement of claim 5 further including a reinforcing bar, said reinforcing bar extending between one side of said mounting plate and an opposite frame member.

7. The improvement of claim 1 wherein said first and second air springs are each triple convoluted air springs.

8. The improvement of claim 4 further including third and fourth air springs.

9. The improvement of claim 8 wherein said third and fourth air springs are double convoluted air springs.
